(19) United States
(12) Patent Application Publication
(10) Pub. No.: US 2008/0019308 A1
(43) Pub. Date: Jan. 24, 2008

(54) RECEPTION OF DATA WITH ADAPTIVE CODE RATE OVER WIRELESS NETWORK

(76) Inventors: KUO CHUAN-LIN, Kweishan (TW); Hung-Yi Chen, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/779,300

(22) Filed: Jul. 18, 2007

(30) Foreign Application Priority Data
Jul. 21, 2006 (TW) 095126852

(51) Int. Cl. H04Q 7/00

(52) U.S. Cl. 370/329

(57) ABSTRACT

The present invention relates to a method for receiving a data by an adaptive code rate over a wireless network. First, a first data packet and a second data packet both corresponding to an identical portion of the data are encoded and received by a first puncturing matrix. If the results of the decoding of the first data packet and the second data packet are both failures, the first data packet combines with the second data packet into a third data packet. Then, the third data packet is decoded to obtain the data. If the result of decoding of the third data packet is still a failure, the portion of the data is encoded by a second puncturing matrix whose code rate is lower than that of the first puncturing matrix. The steps mentioned above are performed repeatedly until the portion of the data is decoded correctly.

### BACKGROUND OF THE INVENTION

1. Field of the Invention

The present invention relates a method for receiving data packets by an adaptive code rate; in particular, the method is particularly applicable in wireless network.

2. Description of the Prior Art

In wireless communication systems, instability of the transmission channels of the transmission environment arises due to the phenomena of refraction, diffraction, interference, and multipath fading caused by ground objects during the transmissions of wireless waves in the air. Thus, the topic of how to correctly receive data through appropriate error-controlling mechanisms becomes an important issue in the development of wireless network.

The antenna diversity technology is used in current wireless networks to increase the probability of correctly receiving data frames. The rationale of the antenna diversity technology is to receive, by the receiving end, several different versions of data packets transmitted from the transmitting end, wherein each version is transmitted and affected by a different channel before being received by the receiving end. Because each of the channels is independent, the probability of the signals in the packets being simultaneously affected by deep fading is substantially decreased, thereby increasing the probability of the packets being correctly received.

However, the wireless communication systems applying the traditionally used antenna diversity technology do not adjust, during error-controlling, the code rates of the data packets in accordance with the conditions of the channels, causing the average transmission time to be longer and the efficiency of the wireless communication systems to be poorer. Accordingly, a scope of the invention is to provide a method capable of adjusting code rates in accordance with conditions of transmission channels and decoding by combining data packets transmitted from different channels to decrease the number of re-transmissions of the packets, so as to achieve the goal of lowering the average transmission time to increase the efficiency of the wireless communication system.

### SUMMARY OF THE INVENTION

In order to resolve the problems described above, a scope of the invention is to provide a method for receiving a data by an adaptive code rate. In particular, the method is particularly applicable in a wireless network.

The preferred embodiment according to the invention is a method for receiving a transmitted data by an adaptive code rate over a wireless network. First, a unique encoding method is selected for encoding the transmitted data such that the encoded data packet has a better resistance to noisy signals. The unique encoding method can encode by a puncturing matrix or a convolution code. The longer is the encoding length, the lower the percentage of encoding. The more complex is the encoding, the better the resistance to noisy signals. Therefore, the first data packet and the second data, respectively received by a first receiver and a second receiver, can be processed by diversity after the data packet is encoded by a first puncturing matrix. If the results of decoding of the first data packet and the second data packet are both failures, a NACK packet is selectively transmitted to the transmitting end, and the first data packet is combined with the second data packet into a third data packet. Then, the third data packet is decoded to obtain the data. If the result of decoding of the third data packet is still a failure, a NACK packet is transmitted to the transmitting end, and the transmitted data mentioned above is encoded by a second puncturing matrix with a lower code rate. On the other hand, if the first data packet, the second data packet, and the third data packet can be correctly decoded, an ACK packet is transmitted to the transmitting end. The steps mentioned above are performed repeatedly until the portion of the data is decoded correctly.

By combining data packets received by different receptors and by adjusting code rates of different puncturing matrices in accordance with conditions of transmission channels, the method described above can decrease the number of re-transmissions, so as to achieve the goal of lowering the average transmission time to increase the efficiency of wireless transmission.

The advantage and spirit of the invention may be understood by the following recitations together with the appended drawings.

### BRIEF DESCRIPTION OF THE APPENDED DRAWINGS

FIG. 1 is a flowchart diagram outlining the method for receiving data according to a first embodiment of the invention.

FIG. 2 is a general diagram of a wireless communication system, according to the second preferred embodiment of the invention, for receiving data by an adaptive code rate over a wireless network.

FIG. 3 is a functional block diagram showing the wireless communication system of the second embodiment of the invention.

### DETAILED DESCRIPTION OF THE INVENTION

A scope of the invention is to provide a method and a communication system for receiving a transmitted data by an adaptive code rate, and in particular, the method and the communication system are particularly applicable to a wireless network.

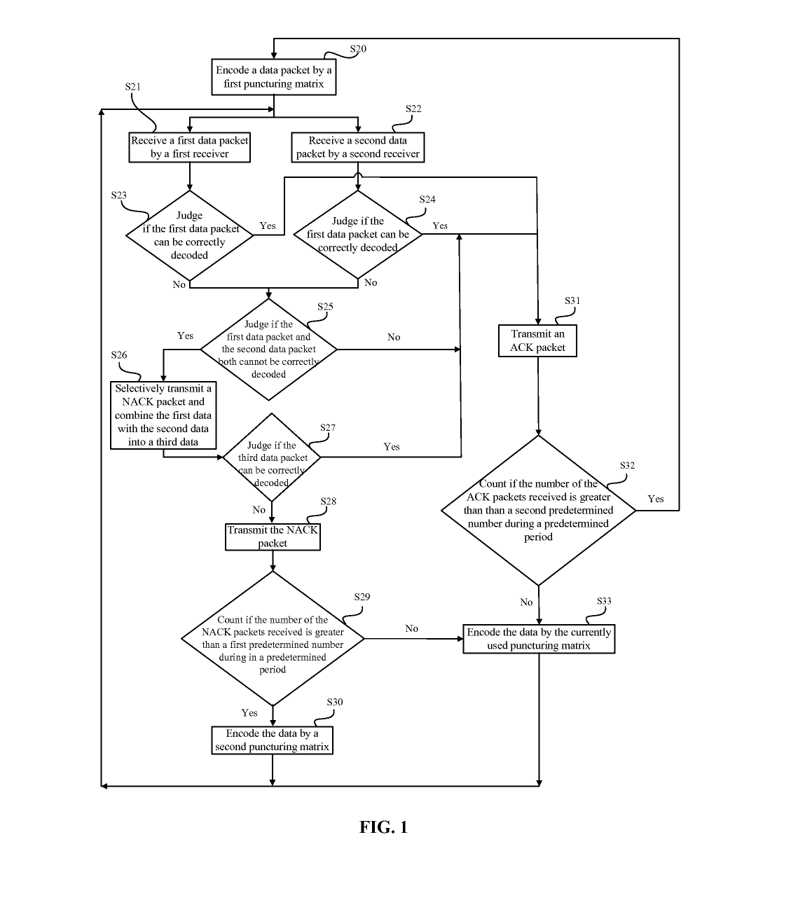

A preferred embodiment according to the invention is a method for receiving data packets by an adaptive code rate over a wireless network. Referring to FIG. 1, FIG. 1 is a flowchart diagram outlining the method for receiving data according to a first embodiment of the invention.

The step S20 of the method is first performed to encode an identical portion of the data by a first puncturing matrix, and then the encoded data is transmitted through the channel. The step S21 is performed to receive a first data packet from a first receiver, and the step S22 is performed to receive a second data packet from a second receiver. The first data packet and the second data packet both correspond to the identical portion of the data. However, because of multi-path transmission effects, the first data packet and the second data packet may be not the same. Then, the step S23 and the step S24 are respectively performed. The step S23 is performed to judge if the first data packet is correctly decoded. On the other hand, the step S24 is performed to judge if the second data packet is correctly decoded. The step S25 is performed to judge whether the first data packet and the second data packet both cannot be correctly decoded. If the result is positive, the step S26 is performed to selectively transmit a NACK packet and to combine the first data packet with second data packet into a third data packet. The decision of whether a NACK packet will be transmitted in the step S25 is made in accordance with statistical needs. A NACK packet is transmitted when hoping to obtain a more accurate judgment; otherwise, the step S28 is performed to also transmit a NACK packet when decoding of all data packets has failed.

Then, the step S27 is performed to judge if the third data packet can be correctly received. If the third data packet still cannot be correctly received after combining, the step S28 is performed to transmit a NACK packet. Then, the step S29 is performed to count the number of the NACK packets received during a predetermined period and to judge if the number is greater than a first predetermined number. If the result of the step S29 is positive, the step S30 is performed to encode the identical portion of the data by a second puncturing matrix, wherein the code rate of the second puncturing matrix is lower than that of the first puncturing matrix. Conversely, if the result of the step S29 is negative, then the step S33 is performed to encode the identical portion of the data by the currently used puncturing matrix. A lower code rate indicates a higher number of redundancy bits is added into the packet, and the transmission rate of the packets is lower. This also indicates that the condition of the transmission channel in the time being is in a poor state. Furthermore, as the number of redundancy bits added into the packet increases, the probability of the packet being correctly decoded will increase, thereby decreasing the number of re-transmission. The step S21 and the step S22 are then repeatedly and respectively performed until the portion of the data is correctly decoded.

In one embodiment of the invention, if the result of the step S27 is negative, it indicates that the third data packet cannot be correctly decoded. The step S30 is then performed to encode the identical portion of the data by a second puncturing matrix, wherein the code rate of the second puncturing matrix is lower than that of the first puncturing matrix.

In the steps described above, if the results of the step S23, the step S24, or the step 27 are positive, the step S31 is performed. Similarly, if the result of the step S25 is negative, the step S31 is performed. An ACK packet is transmitted in the step S31. Then, the step S32 is performed to count the number of ACK packets received during a predetermined period and to judge if the number is greater than a second predetermined number. If the result of the step S32 is negative, the step S33 is performed to encode the data to be transmitted by the currently used puncturing matrix. Conversely, if the result of the step S32 is positive, the step S20 is performed again to encode the data to be transmitted by the first puncturing matrix.

In one embodiment of the invention, the combining of the first data packet with the second data packet is achieved by implementing an algorithm of average diversity combining. For example, the weighted ratio of the third data packet created by combining the first data packet with the second data packet is determined in accordance with the signal to noise ratio (SNR) measured in the physical layers of the first receiver and the second receiver. The greater is the value of the SNR, the higher the weighted ratio.

In one embodiment of the invention, the combining of the first data packet with the second data packet is achieved by implementing an algorithm of interleaving. For example, the first data packet and the second data packets are both divided into N blocks, wherein N is a positive integer greater than 1. The odd number of the blocks of the first data packet is combined with the even number of the blocks of the second data packet into the third packet, or the even number of the blocks of the first data packet is combined with the odd number of blocks of the second packet into the third packet.

In one embodiment of the invention, the combining of the first data packet and the second data packet is achieved by combining a first block of the first data packet with a second block of the second data packet. For example, the first half of the first data packet is combined with the second half of the second data packet into the third data packet.

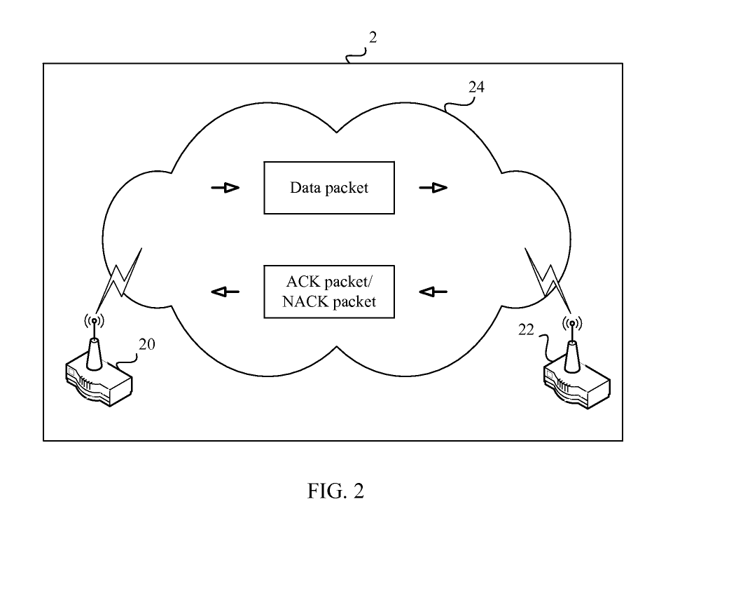

Referring to FIG. 2, FIG. 2 is a general diagram of a wireless communication system, according to second preferred embodiment of the invention, for receiving data by an adaptive code rate over a wireless network. The wireless communication system 2 includes a first communication device 20 and a second communication device 22. The first communication device 20 is used for receiving a first data packet.

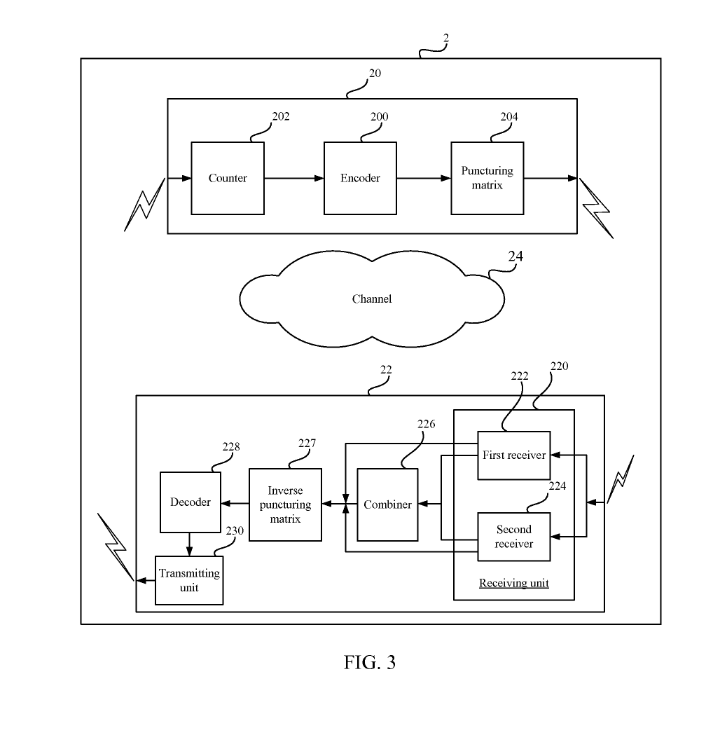

Referring to FIG. 3, FIG. 3 is a functional block diagram showing the wireless communication system of the second embodiment of the invention. The second communication device includes a receiving unit 220, a combiner 226, a decoder 228, and a transmitting unit 230. The receiving unit 220 further includes a first receiver 222 and a second receiver 224. During a predetermined period, the first receiver 222 is used for receiving the second data packet, and the second receiver 224 is used for receiving the third data packet. The second data packet and the third data packet are identical to the first data packet. The combiner 226 is used for combining the second data packet with the third data packet into a fourth data packet. The decoder 228 is used for decoding the fourth data packet. The transmitting unit 230 is used for transmitting an ACK packet or a NACK packet to the first communication device 20.

The first communication device 20 includes an encoder 200 and a counter 202. The encoder 200 is used for encoding a portion of a data into the first data packet. The counter 202 is used for counting a number of the ACK packets and a number of the NACK packets.

After the first receiver 222 and the second receiver 224 of the second communication device 22 respectively receives the second data packet and the third data packet, the decoder 228 respectively decodes the second data packet and the third data packet to obtain the data. If the second data packet and the third data packet both cannot be correctly decoded, the transmitting unit 230 transmits a NACK packet to the first communication device 20 and combines the second data packet with the third data packet into a fourth data packet.

If the decoder 228 of the second communication device 22 still cannot decode the fourth data packet, the transmitting unit 230 transmits a NACK packet to the first communication device 20. During a predetermined period, the counter 202 of the first communication device 20 counts the number of NACK packets received. If the number is greater than a first predetermined number, the encoder 200 of the first communication device 20 encodes the identical portion of the data by a second puncturing matrix 204, wherein the code rate of the second puncturing matrix 204 is lower than that of the first puncturing matrix 204. Conversely, if the number of the NACK packet is smaller than or equal to the first predetermine number, the encoder 200 of the first communication device 20 encodes the identical portion of the data by the currently used puncturing matrix 204. Then, the first communication device 20 retransmits the encoded data packet until the portion of the data is correctly decoded.

Furthermore, if one of the second data packet and the third data packet can be correctly decoded by the decoder 228 of the second communication device 22, the transmitting unit 230 transmits an ACK packet to the first communication device 20. Similarly, if the decoder 228 can correctly decode the fourth data packet, the transmitting unit 230 also transmits an ACK packet to the first communication device 20. During a predetermined period, the counter 202 of the first communication device 20 counts the number of ACK packets received. If the number is greater than a second predetermined number, the encoder 200 of the first communication system 20 encodes the data to be transmitted by the first puncturing matrix 204. Conversely, if the number of the ACK packets is smaller than or equal to the second predetermined number, the first communication device 20 encodes the data by the currently used puncturing matrix 204.

In one embodiment of the invention, the combiner 226 of the second communication device 22 combines the second data packet with the third data packet into the fourth data packet by implementing an algorithm of average diversity combining. For example, the weighted ratio of the fourth data packet created by combining the second data packet and the third data packet is determined in accordance with SNR measured in the physical layers of the first receiver 222 and the second receiver 224. The greater is the value of the SNR is, the higher the weighted ratio.

In one embodiment of the invention, the combiner 226 of the second communication device 22 combines the second data packet with the third data packet into a fourth data packet by implementing an algorithm of interleaving. For example, the second data packet and the third data packets are both divided into N blocks, wherein N is a positive integer greater than 1. The odd number of blocks of the second data packet is combined with the even number of blocks of the third data packet into the fourth packet, or the even number of the blocks of the second data packet is combined with the odd number of blocks of the third packet into the fourth packet.

In an embodiment of the invention, the combiner 226 of the second communication device 22 combines a first block of the second data packet with a second block of the third data packet into the fourth data packet. For example, the first half of the second data packet is combined with the second half of the third data packet into the fourth data packet.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for receiving data, comprising:
(a) receiving a first data packet and a second data packet, the first data packet and the second data packet both corresponding to a portion of the data;
(b) combining the first data packet and the second data packet into a third data packet; and
(c) decoding the third data packet to obtain the portion of the data.

2. The method of claim 1, wherein the first data packet and the second data packet are encoded by a first puncturing matrix.

3. The method of claim 2, if decoding the third data packet failed, said method further comprising:
encoding the first data packet and the second data packet by a second puncturing matrix, wherein the code rate of the second puncturing matrix is lower than that of the first puncturing matrix.

4. The method of claim 2, if decoding the third data packet failed, said method further comprising:
transmitting a negative acknowledgement (NACK) packet;
counting a number of NACK packets received during a predetermined period; and
encoding the data by a second puncturing matrix if the number of the NACK packets is greater than a first predetermined number, wherein the code rate of the second puncturing matrix is lower than that of the first puncturing matrix.

5. The method of claim 4, if decoding the third data packet succeeded, said method further comprising:
transmitting an acknowledgement (ACK) packet;
counting a number of ACK packets received during a predetermined period; and
encoding the data by the first puncturing matrix if the number of the ACK packets is greater than a second predetermined number.

6. The method of claim 1, further comprising:
decoding the first data packet and the second data packet to obtain the portion of the data; and
transmitting an ACK packet if decoding the first data packet succeeded or decoding the second data packet succeeded.

7. The method of claim 1, further comprising:
decoding the first data packet and the second data packet to obtain the portion of the data; and
transmitting a NACK packet if decoding of the first data packet and the second data packet.

8. The method of claim 1, further comprising:
providing a first receiver and a second receiver; and
receiving the first data packet by the first receiver and receiving the second data packet by the second receiver during a predetermined period.

9. The method of claim 1, wherein the combining of the first data packet with the second data packet is achieved by implementing an algorithm of average diversity combining (ADC).

10. The method of claim 1, wherein the combining of the first data packet with the second data packet is achieved by implementing an algorithm of interleaving.

11. The method of claim 1, wherein the combining of the first data packet with the second data packet is achieved by combining a first block of the first data packet and a second block of the second data packet.

12. A wireless communication system, comprising:
a first communication device for transmitting a first data packet; and
a second communication device, comprising:
a receiving unit for receiving a second data packet and a third data packet, the second data packet and the third data packet being both identical to the first data packet;
a combiner for combining the second data packet and the third data packet into a fourth data packet; and
a decoder for decoding the fourth data packet.

13. The wireless communication system of claim 12, wherein the first communication device comprises:
an encoder for encoding a portion of a data into the first data packet by a first puncturing matrix.

14. The wireless communication system of claim 13, wherein the second communication device further comprises:
a transmitting unit for transmitting a negative acknowledgement (NACK) packet to the first communication device if decoding the fourth data packet failed.

15. The wireless communication system of claim 14, wherein the first communication device further comprises:
a counter for counting a number of NACK packets;
wherein if the number of NACK packets is greater than a first predetermined number, the encoder of the first communication device encodes the data by a second puncturing matrix, the code rate of the second puncturing matrix is lower than the code rate of the first puncturing matrix.

16. The wireless communication system of claim 15, wherein if the decoder of the second communication device successfully decodes the fourth data packet, the transmitting unit of the second communication device transmits an acknowledgement (ACK) packet to the first communication device.

17. The wireless communication system of claim 16, wherein if a number of the ACK packets counted by the counter is greater than a second predetermined number, the encoder of the first communication device encodes the data by the first puncturing matrix.

18. The wireless communication system of claim 12, wherein the decoder of the second communication device decodes the second data packet and the third data packet, respectively, to obtain the data before the combiner combines the second data packet and the third data packet into the fourth data packet.

19. The wireless communication system of claim 18, wherein if the decoder of the second communication device successfully decodes the second data packet or the third data packet, the transmitting unit transmits an ACK packet to the first communication device.

20. The wireless communication system of claim 18, wherein if the decoder of the second communication device decodes the second data packet and the third data packet failed, the transmitting unit transmits a NACK packet to the first communication device.
